(19) United States
(12) Patent Application Publication
(10) Pub. No.: US 2007/0104887 A1
(43) Pub. Date: May 10, 2007

(54) CONDUCTIVE TONER AND PROCESS FOR PRODUCING GLASS PLATE WITH CONDUCTIVE PRINTED WIRING

(75) Inventors: Satoshi Kashiwabara, Tokyo (JP); Kazuo Sunahara, Tokyo (JP); Naoki Okahata, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: ASAHI GLASS COMPANY, LIMITED, Tokyo (JP)

(21) Appl. No.: 11/564,922

(22) Filed: Nov. 30, 2006

Related U.S. Application Data
(63) Continuation of application No. PCT/JP05/01257, filed on Jul. 7, 2005.

(30) Foreign Application Priority Data
Jul. 9, 2004 (JP) 2004-203556

(51) Int. Cl. B05D 1/32; C03C 25/24

(52) U.S. Cl. 427/466; 65/447

(57) ABSTRACT

A process for producing a glass plate with conductive printed wiring which does not require a new screen for each model and which can easily be adjusted for desired electric heating performance or antenna performance, and a conductive toner for such a process.

A conductive toner comprising at least one member selected from the group consisting of a thermoplastic resin (A) having carboxyl groups introduced and having T₁₀₀ of from 300 to 450° C., a polypropylene (B) having carboxyl groups introduced, and a thermoplastic resin (C) having T₁₀₀ of from 300 to 450° C., conductive fine particles, and glass frit-containing particles. T₁₀₀ is a temperature at the time when a weight change of the resin has become no longer observed during a temperature rise from room temperature at a rate of 10° C./min by means of a thermogravimetric analyzer (TG).

### TECHNICAL FIELD

The present invention relates to a conductive toner and a process for producing a glass plate with conductive printed wiring. Particularly, it relates to a conductive toner capable of forming a conductive printed wiring excellent in adhesion to a glass plate to be used for a window of an automobile or the like, and a process for producing a glass plate with conductive printed wiring.

### BACKGROUND ART

A glass plate to be used for a window of an automobile, is provided with conductive printed wiring as heater wires for defogging or as antenna wiring for receiving radio, television or the like. Such conductive printed wiring is provided mainly on a rear window or on a rear side window of an automobile. The conductive printed wiring consists mainly of a fired product of a paste containing silver. Specifically, a paste having silver and glass frit incorporated in a resin solution, is printed on a glass plate in a predetermined pattern by screen printing, and then the glass plate is heated to decompose the resin content and to fix silver on the glass plate by the glass frit, followed by firing silver to form conductive printed wiring on the glass plate.

There is a restriction to the voltage in the electrical system to be used for an automobile, and in order to obtain the desired heat generation, it is necessary to set the resistance of heater wires at a prescribed level. Further, in order to receive radio waves by a prescribed antenna pattern, it is necessary to set the resistance of the antenna wiring at a prescribed level. The resistance of the conductive printed wiring depends on the wiring width or wiring thickness.

On the other hand, in order to sufficiently remove fogging or to receive radio waves with a desired sensitivity over the entire region of a window, it is necessary to design a pattern for the heater wires or antenna wiring. By a computer simulation, it is possible to predict to some extent how much fogging can be removed or what grade of antenna performance can be obtained by such a pattern. Further, it has been proposed to simply adhere a conductive tape on a glass plate to preliminarily measure various performances (e.g. Patent Document 1). However, to know the final performance for removal of fogging or antenna performance, it is necessary to actually provide conductive printed wiring and measure the respective performances.

Accordingly, there may be a case wherein even after the preparation of a screen based on the prediction of substantially the final stage and production of a conductive printed glass plate, the pattern of the conductive printed wiring will have to be changed. In such a case, the screen has to be modified to meet the modified pattern.

Automobiles are mass production products, and likewise window glass plates to be used for automobiles are mass production products. Accordingly, once a pattern is determined for conductive printed wiring, it is required that a conductive paste is sequentially printed on a large quantity of glass plates in the determined pattern. In such mass production, screen printing of a conductive paste by means of a screen is suitable. However, as mentioned above, even if a screen having a pattern substantially determined, is prepared, it will be necessary to modify the screen to have the pattern adjusted to make the heat generation performance or antenna performance to be finally desired. Besides, in a case where the glass plates are to be used for windows of automobiles, the shapes of the glass plates, the shapes of patterns of conductive printed wirings, etc. may vary depending upon the types of the automobiles. Accordingly, depending upon the types of the automobiles, screens will have to be prepared, and many screens will have to be stocked. Thus, it is desired to develop a process for producing glass plates with conductive printed wiring, whereby no modification of a screen is required, and to develop a conductive composition for such a process.

In order to solve such a problem, it has been proposed in recent years to print a conductive toner (ink) comprising conductive fine particles made of metal such as silver and a thermoplastic resin on an inorganic substrate by an electro printing method, followed by firing to form a conductive wiring pattern, and various conductive toners for such a purpose have been proposed. As a typical example, a conductive toner (Patent Document 2) has been proposed wherein conductive fine particles are covered with a thermoplastic resin to form capsules, to which glass frit, etc. are added. However, in such a conductive toner, a thermoplastic resin such as a styrene/acrylic resin is used, and when fired, such a resin will remain as a char in the conductive printed wiring to block sintering of the conductive fine particles to one another, whereby the electrical characteristic (the resistance) of the obtained conductive print was not adequate as a wiring pattern. Further, the adhesion of the conductive printed wiring to the inorganic substrate after the firing was not satisfactory.

Patent Document 1: JP-A-2003-188622 (Claims)

Patent Document 2: JP-A-2002-244337 (Claims)

### DISCLOSURE OF THE INVENTION

### Object to be Accomplished by the Invention

The present invention relates to a conductive toner and a process for producing a glass plate with conductive printed wiring. Particularly, it is an object of the present invention to provide a conductive toner capable of forming conductive printed wiring excellent in adhesion to the glass plate to be used for a window of e.g. an automobile, and a process for producing a glass plate with conductive printed wiring.

### MEANS TO ACCOMPLISH THE OBJECT

The present invention provides a conductive toner as defined in the following (1) to (10) and a process for producing a glass plate with conductive printed wiring as defined in the following (11) to (15).

(1) A conductive toner comprising a thermoplastic resin (A) having carboxyl groups introduced and having T₁₀₀ of from 300 to 450° C., conductive fine particles, and glass frit-containing particles, where T₁₀₀ is a temperature at the time when a weight change of the resin has become no longer observed during a temperature rise from room temperature at a rate of 10° C./min by means of a thermogravimetric analyzer (TG).

(2) The conductive toner according to (1), wherein the thermoplastic resin (A) has an acid value of from 20 to 100.

(3) The conductive toner according to (1) or (2), wherein (T₁₀₀−T₉₀) of the thermoplastic resin (A) is from 1 to 15° C., where T₉₀ is a temperature at the time when weight reduction of the resin has become 90 wt % during a temperature rise from room temperature at a rate of 10° C./min by means of a thermogravimetric analyzer (TG).

(4) The conductive toner according to any one of (1) to (3), wherein the absolute value of the difference between the melting temperature Ts of the glass frit and said T₁₀₀ is at most 20° C.

(5) A conductive toner comprising a polypropylene (B) having carboxyl groups introduced, conductive fine particles, and glass frit-containing particles.

(6) The conductive toner according to (5), wherein the polypropylene (B) has an acid value of from 20 to 100.

(7) The conductive toner according to (5) or (6), wherein (T₁₀₀−T₉₀) of the polypropylene (B) is from 1 to 15° C., where T₁₀₀ and T₉₀ are a temperature at the time when a weight change of the resin has become no longer observed, and a temperature at the time when weight reduction of the resin has become 90 wt %, respectively, during a temperature rise from room temperature at a rate of 10° C./min by means of a thermogravimetric analyzer (TG).

(8) The conductive toner according to any one of (5) to (7), wherein the absolute value of the difference between the melting temperature Ts of the glass frit and said T₁₀₀ is at most 20° C.

(9) A conductive toner comprising a thermoplastic resin (C) having T₁₀₀ of from 300 to 450° C., conductive fine particles, and glass frit-containing particles, wherein the difference (Ts−T₁₀₀) between the melting temperature Ts of the glass frit and T₁₀₀ of the thermoplastic resin (C) is at most 20° C., and the difference (Ts−T₉₀) between said Ts and T₉₀ of the thermoplastic resin (C) is from 0 to 80° C., where T₁₀₀ and T₉₀ are a temperature at the time when a weight change of the resin has become no longer observed, and a temperature at the time when weight reduction of the resin has become 90 wt %, respectively, during a temperature rise from room temperature at a rate of 10° C./min by means of a thermogravimetric analyzer (TG).

(10) The conductive toner according to any one of (1) to (9), wherein the glass frit has a melting temperature of from 350 to 500° C.

(11) A process for producing a glass plate with conductive printed wiring, which comprises a step of printing the conductive toner as defined in any one of (1) to (10) on a glass plate and a step of heating the glass plate having the toner printed thereon at a predetermined temperature and firing the toner, thereby to form a conductive printed wiring having a predetermined pattern on the glass plate, wherein in the printing step, the toner is printed on the glass plate by electro printing.

(12) The process for producing a glass plate with conductive printed wiring according to (11), wherein after the step of firing the toner, the resistance of the conductive printed wiring formed on the glass plate is measured and the measured result is fed back to the printing step to adjust the printing width of toner.

(13) The process for producing a glass plate with conductive printed wiring according to (11) or (12), wherein after the step of firing the toner, the resistance of the conductive printed wiring formed on the glass plate is measured and the measured result is fed back to the printing step to adjust the printing pattern of toner.

(14) The process for producing a glass plate with conductive printed wiring according to any one of (11) to (13), wherein in the printing step, together with said toner, a colored toner is printed on the glass plate.

(15) The process for producing a glass plate with conductive printed wiring according to any one of (11) to (14), wherein the step of firing the toner is carried out at a temperature of from 600 to 740° C.

### EFFECTS OF THE INVENTION

According to the present invention, a conductive toner is printed in a predetermined pattern on a glass plate by electro printing, and the toner is fired to provide a conductive printed wiring having a predetermined pattern on the glass plate, whereby it is possible to form a conductive printed wiring excellent in adhesion to the glass plate without necessity to prepare a new screen for every pattern. Especially in a case where a conductive printed wiring obtained after the firing does not provide a desired heat generation performance or antenna performance, it is easily possible to correct it to the desired heat generation performance or antenna performance by feeding back the resistance of the obtained conductive printed wiring to the printing step to adjust the printing pattern or width.

### BRIEF DESCRIPTION OF DRAWINGS

FIG. 1 is a schematic side view illustrating an example of a continuous process for producing a glass plate with conductive printed wiring of the present invention.

FIG. 2 is a schematic view illustrating a control process relating to a preferred embodiment of the present invention.

FIG. 3 is a front view illustrating an example of a rear window of an automobile.

### MEANING OF SYMBOLS

1: Defogger

2: Antenna wiring

3: Busbar

4: Dark colored ceramic fired product

10: Electro printing apparatus

11: Toner feeder

12: Electrification device

13: Photoconductor drum

14: Static eliminator

15: Light source

20: Conveyor roll

30: Heating furnace

G: Glass plate

C: Computer

ST1: Chamfering step

ST2: Printing step

ST3: Firing step

ST4: Inspection step

### BEST MODE FOR CARRYING OUT THE INVENTION

Now, an embodiment of the present invention will be described with reference to the drawings.

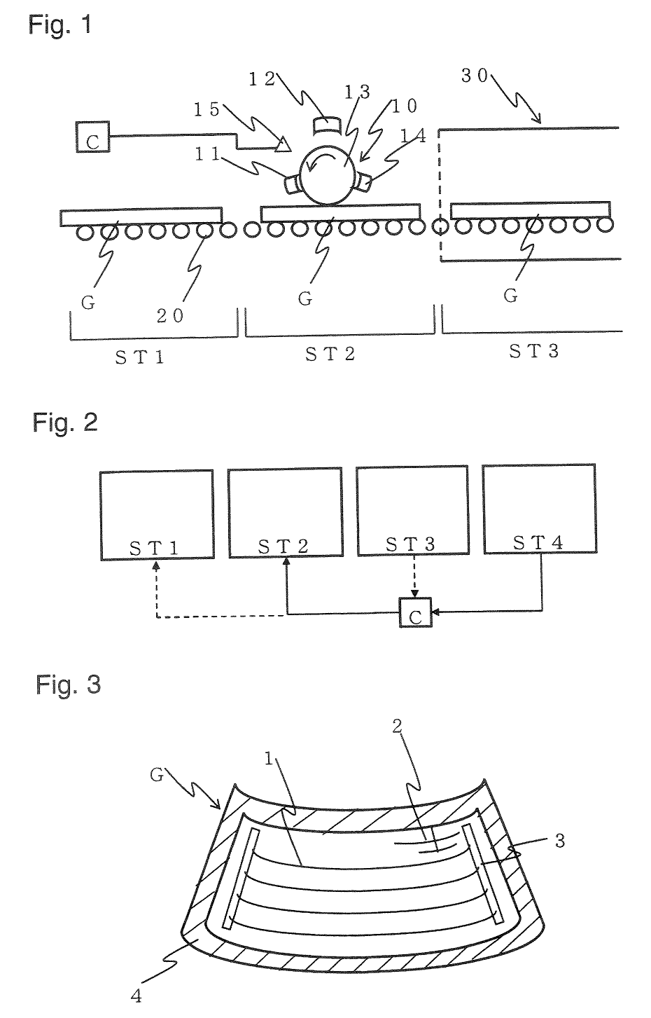

FIG. 1 is a schematic side view illustrating an example of a continuous process for producing a glass plate with conductive printed wiring of the present invention. The glass plate G is transported to a printing step via a step (ST1) of cutting into a predetermined shape, chamfering, cleaning, etc. In the printing step ST2, a conductive toner containing conductive fine particles is printed in a predetermined pattern on the glass plate G by an electro printing apparatus 10. The glass plate G having the toner printed in a prescribed pattern is transported into a heating furnace 30. In the heating furnace 30, the glass plate G is heated to a predetermined temperature, and the toner is fired to the glass plate G, whereby a glass plate having a conductive printed wiring of a predetermined pattern is prepared. The formed conductive printed wiring is transported to an inspection step (ST4, not shown) and inspection of the resistance value is carried out. The result of the inspection in the inspection step ST4 is transmitted to a computer C, whereupon after being judged whether or not the desired electro heating performance or antenna performance is obtainable, it is converted to information for adjustment to a predetermined pattern or wiring width of toner, which is utilized for the control of the printing pattern in a printing step ST2.

In the step ST1, a rectangular glass plate is cut into a predetermined shape, and the cut surface is chamfered. Then, the glass plate is cleaned and, if necessary, preheated and transported to the printing step ST2 by conveyor rolls 20.

In the printing step ST2, a photoconductor drum 13 is subjected to removal of electricity by a static eliminator 14 while the photoconductor drum is rotated. Then, the photoconductor drum is charged by an electrification device 12 and irradiated with an exposure light from a light source 15 to have the photoconductor drum exposed with a predetermined pattern. Then, the exposed surface of the photoconductor drum 13 is rotated to a toner feeder 11 for presenting a toner to the photoconductor drum, whereby a toner layer is formed in a predetermined pattern on the surface of the photoconductor drum 13. The toner layer in the predetermined pattern on the surface of the photoconductor drum 13 will be transferred to the surface of a glass plate G transported by the rotation of the photoconductor drum 13. Thus, a toner layer of a predetermined pattern is formed on the surface of the glass plate G. At that time, a secondary transfer plate such as an intermediate transfer belt may be interposed between the photoconductive drum 13 and the surface of the glass plate G.

In the computer C, the pattern information to have exposure light irradiated to carry out exposure in a predetermined pattern, is stored. Accordingly, by a direction from the computer C, an exposure light from the light source 15 is irradiated in a predetermined pattern. In a case where the glass plate G is to be used for a window of an automobile, the shape of the glass plate, the pattern shape of the conductive printed wiring, etc. vary depending upon the type of the automobile. Accordingly, on the basis of such data corresponding to the type of the automobile, the instruction signal may be changed, and it is thereby possible to easily change from the production of a glass plate of a certain type to the production of a glass plate of another type.

The glass plate G having a toner layer of a predetermined pattern, is transported into a heating furnace 30 and heated at a predetermined temperature, usually from about 600 to 740° C. The toner is thereby fired to the surface of the glass plate G, whereby a conductive printed wiring of a predetermined pattern is formed on the glass plate. Usually, a glass plate for a window of an automobile is curved. Accordingly, when the conductive printed wiring glass plate prepared as described above, is to be used for a window of an automobile, it is heated in the firing step ST3 and subjected to reinforcing treatment via bending processing. Here, there may be a case where instead of reinforcing treatment, annealing treatment may be carried out (bending of the glass plate for laminated glass).

The conductive toner of the present invention (hereinafter referred to as the present toner) comprises at least one member selected from the group consisting of resins (A), (B) and (C) (hereinafter referred to simply as “the resins (A) to (C)”), conductive fine particles and glass frit-containing particles. In this case, the present toner is fixed to the glass plate by the tackiness of the resins (A) to (C) before heating. In the subsequent heating step, firstly the resins (A) to (C) will be decomposed. The decomposed resins (A) to (C) will be volatilized from the glass plate by heating. After the majority of the resins (A) to (C) have been volatilized, the glass frit starts to be melted, and the present toner will be fixed on the glass plate surface mainly by the adhesive property of the glass frit. In such a process, the resins (A) to (C) are permitted to be completely decomposed and volatilized before the glass frit is completely melted, whereby the amount of the resin remaining in the conductive printed wiring after the firing can be reduced. Finally, the glass plate is heated to a temperature exceeding 600° C., whereby the conductive fine particles will be sintered, and the conductive fine particles will be contacted and bonded to one another, and at the same time, the molten glass frit will fill spaces between the conductive fine particles.

The conductive fine particles may, for example, be metal fine particles or conductive oxide fine particles. As the metal fine particles, fine particles of gold, platinum, silver or copper are preferred. As the conductive oxide fine particles, fine particles of ITO (indium-doped tin oxide) or ATO (antimony-doped tin oxide) are preferred. In a case where the glass plate with conductive printed wiring is to be used for a window of an automobile, the width of the conductive printed wiring can not be made so large, since it is necessary to ensure that the formed conductive printed wiring will not block the eyesight. Accordingly, it is particularly preferred to select fine particles of silver as the conductive fine particles in order to obtain a desired resistance value with a narrow wiring width.

The content of the conductive fine particles is preferably from 60 to 95 parts by mass per 100 parts by mass of the total solid content of the present toner. When the content of the conductive fine particles is at least 60 parts by mass, the electrical conductivity of the conductive printed wiring can sufficiently be maintained, and the volume shrinkage of the obtained conductive printed wiring after the firing can be suppressed, whereby its peeling from the glass plate surface or cracking can be prevented. Further, when it is at most 95 parts by mass, constant electrification can be attained as a toner. The content of the conductive fine particles is particularly preferably from 80 to 90 parts by mass.

The conductive fine particles preferably has an average particle size of from 0.2 to 20 μm. When the average particle size is at least 0.2 μm, the volume shrinkage of the obtainable conductive printed wiring will be suppressed, and its peeling from the glass plate surface can be prevented. On the other hand, when the average particle size is at most 20 μm, the print quality of the obtainable conductive printed wiring can be made high. The conductive fine particles particularly preferably have an average particle size of from 0.5 to 10 μm.

In the present toner, the resins (A) to (C) are adopted as a binder which is excellent in the fixing property to the glass plate surface and which is excellent also in the decomposition property during the heat treatment. The reason for the excellent fixing property is not clearly understood, but it is considered that when the resin (A) or (B) is employed, carboxyl groups in the resin (A) or (B) perform an action such as chemical bonding with silanol groups at the surface of the glass plate to provide such an excellent fixing property. The reason for the excellent fixing property in the case where the resin (C) is employed, will be described hereinafter.

The resins (A) and (C) have T₁₀₀ of from 300 to 450° C. Further, the resin (B) preferably has T₁₀₀ of from 300 to 450° C. In the present invention, T₁₀₀ is a temperature at the time when a weight change has become no longer observed in the measurement of the weight change of the resins (A) to (C) by raising the temperature from room temperature at a rate of 10° C./min by means of a thermogravimetric analyzer (TG). When T₁₀₀ is at least 300° C., it is possible to prevent complete decomposition of the resins (A) to (C) before the glass frit is melted and it is possible to sufficiently fix the conductive printed wiring to the glass plate surface. On the other hand, when T₁₀₀ is at most 450° C., when the toner is fired, the resins (A) to (C) will be readily decomposed and volatilized, whereby it will scarcely remain as a residual carbon in the conductive printed wiring, and a conductive printed wiring excellent in the electrical conductivity can be obtained without blocking the sintering of the conductive fine particles to one another, and further, it is possible to obtain a conductive printed wiring excellent in adhesion. T₁₀₀ is particularly preferably from 400 to 450° C.

The resins (A) and (B) preferably have an acid value of from 20 to 100. It is thereby possible to form a pattern excellent in the fixing property when the present toner is electro-printed on a glass plate surface. When the acid value is at least 20, the number of carboxyl groups can be secured, whereby the fixing property of the pattern will be stabilized, and adhesion failure of the conductive printed wiring after the firing will scarcely result. On the other hand, when the acid value is at most 100, the melt viscosity of the resins (A) and (B) will not be too high, and the present toner can be sufficiently fixed to the glass plate surface by electro printing, and a failure such as offset on the transfer roll will scarcely result. The acid value is particularly preferably from 30 to 70.

Further, (T₁₀₀−T₉₀) of the resins (A) to (C) is preferably from 0.1 to 15° C. Here, T₉₀ is a temperature at the time when weight reduction of the resin has become 90 wt % during a temperature rise from room temperature at a rate of 10° C./min by means of a thermogravimetric analyzer (TG). When (T₁₀₀−T₉₀) is at least 0.1° C., a small amount of the resins (A) to (C) is remaining even at the time when the glass frit starts to be melted, whereby in the vicinity of Ts, the conductive printed wiring can be better fixed to the glass plate surface by the adhesive property of both the resin and the glass frit, and it is thereby possible to increase the adhesion of the conductive printed wiring to the glass plate surface. On the other hand, when (T₁₀₀−T₉₀) is at most 15° C., the resins (A) to (C) can be sufficiently decomposed before the glass frit is completely melted, whereby the resins (A) to (C) will scarcely remain as a char in the conductive printed wiring, and sintering failure of the conductive is fine particles to one another will scarcely result. (T₁₀₀−T₉₀) is particularly preferably from 5 to 15° C.

The content of the resins (A) to (C) is preferably from 5 to 40 parts by mass per 100 parts by mass of the total solid content of the present toner. When the content is at least 5 parts by mass, in a case where the present toner is electro-printed, its fixing property to the glass plate surface can adequate be secured. When the content is at most 40 parts by mass, the resins (A) to (C) tend to scarcely remain in the conductive printed wiring after the firing, whereby defects such as cracks or voids tend to scarcely result in the conductive printed wiring. The content of the resins (A) to (C) is particularly preferably from 10 to 30 parts by mass.

As the resin (A) or the resin (C), it is particularly preferred to employ polypropylene, since constant electrification can thereby be easily secured as a toner. Further, as the resins (A) to (C), a maleic anhydride-modified polypropylene or citric acid-modified polypropylene may, for example, be preferred from the viewpoint of the degree of electrification, the rising speed for the electrification and the stability of the electric charge.

As the glass frit, any glass frit may be used irrespective of lead-type or non-lead-type. However, from the viewpoint of environment, etc., a bismuth-silica glass frit of non-lead-type is preferred. The melting temperature Ts of the glass frit is preferably from 350 to 500° C. When the melting temperature Ts of the glass frit is at least 350° C., it is possible to prevent melting of the glass frit before the decomposition of the resins (A) to (C), whereby it is possible to reduce the adhesion failure of the conductive printed wiring or the sintering failure of the conductive fine particles to one another. On the other hand, when the melting temperature Ts is at most 500° C., it is possible to prevent complete decomposition and volatilization of the resins (A) to (C) before the melting of the glass frit, whereby the fixing property of the present toner will not be lowered, and it is possible to secure the adhesion of the conductive printed wiring to the glass plate surface.

Now, in a case where the resin (C) is employed, the difference (Ts−T₁₀₀) between the melting temperature Ts of the glass frit and T₁₀₀ of the thermoplastic resin (C) is at most 20° C. When (Ts−T₁₀₀) is at most 20° C., it is possible to initiate melting of the glass frit before the resin (C) is completely decomposed and volatilized, and it is possible to increase the adhesion of the conductive printed wiring to the glass plate surface. In addition to the above, the difference (Ts−T₉₀) between the Ts and T₉₀ of the resin (C) is made to be from 0 to 80° C. When (Ts−T₉₀) is at least 0° C., a small amount of the resin (C) still remains even at the time when the glass frit starts to be melted, whereby in the vicinity of Ts, the conductive printed wiring can be fixed to the glass plate surface by the adhesive property of both the resin (C) and the glass frit. Thus, the conductive printed wiring is believed to be sufficiently adhered to the glass plate surface. On the other hand, when (Ts−T₉₀) is at most 80° C., the resin (C) can be sufficiently decomposed before the glass frit is completely melted, whereby it is considered that the resin (C) tends to scarcely remain as a char in the conductive printed wiring, sintering failure of the conductive fine particles to one another tends to hardly result, and the adhesion of the conductive printed wiring to the glass plate surface can be made high.

Here, in the present toner, (Ts−T₉₀) is preferably from 0.1 to 50° C. When (Ts−T₉₀) is at least 0.1° C., a small amount of the resins (A) to (C) still remains even at the time when the glass frit starts to be melted, whereby in the vicinity of Ts, the conductive printed wiring can be fixed to the glass plate surface by the adhesive properties of both the resins (A) to (C) and the glass frit, and the conductive printed wiring can sufficiently be adhered to the glass plate surface. On the other hand, when (Ts−T₉₀) is at most 50° C., the resins (A) to (C) can sufficiently be decomposed before the glass frit is completely melted, whereby the resins (A) to (C) tend to scarcely remain as a char in the conductive printed wiring, and sintering failure of the conductive fine particles to one another tends to scarcely result, whereby the adhesion of the conductive printed wiring to the glass plate surface can be increased.

Further, the content of the glass frit is preferably from 0.2 to 5 parts by mass per 100 parts by mass of the total solid content of the present toner. When the content of the glass frit is at least 0.2 part by mass, the adhesion of the conductive printed wiring to the glass plate surface can sufficiently be secured. On the other hand, when the content is at most 5 parts by mass, it is possible to suppress an increase of the resistivity of the conductive printed wiring by an increase of the amount of the glass frit component relative to the conductive fine particles. Further, the glass frit is preferably a powder having an average particle size of from 0.1 to 5 μm. When the average particle size of the glass frit is at least 0.1 μm, its adhesion to the glass plate surface can sufficiently be secured, and when the average particle size is at most 5 μm, it is possible to prevent exposure of the glass frit on the surface of the particles of the present toner, and the fixing property tends to scarcely decrease when the toner is printed on the glass plate surface by an electro printing method. The glass frit particularly preferably has an average particle size of from 0.5 to 3 μm.

To the present toner, an inorganic pigment such as black iron oxide, cobalt blue or iron oxide red, an azo-type metal-containing dye, a salicylic acid-type metal-containing dye, or a charge-controlling agent such as a quaternary ammonium salt may, for example, be incorporated as the case requires.

The present toner is produced, for example, by mixing the resins (A) to (C), the conductive fine particles and the glass frit, etc., followed by kneading and cooling to prepare pellets, which are then pulverized and classified. The heating temperature is preferably from 150 to 200° C. When the heating temperature is at least 150° C., mixing of the resins (A) to (C), the conductive fine particles and the glass frit, etc. can be carried out uniformly. On the other hand, when the heating temperature is at most 200° C., decomposition of the resins (A) to (C) can be avoided. The average particle size of the present toner is preferably from 5 to 50 μm. When the average particle size is at least 5 μm, the conductive fine particles in the present toner are exposed on the surface, and the electrification of the present toner can be secured, whereby during the electro printing, it is possible to avoid a printing defect such as fogging due to inadequate electrification of the present toner. When the average particle size is at most 50 μm, a highly precise printing quality can be readily obtainable.

The present toner thus obtained is printed on a glass plate by electro printing and then fired to form a conductive printed wiring. The firing temperature is preferably from 600 to 740° C. When the firing temperature is at least 600° C., the conductive fine particles will be sufficiently sintered to one another. On the other hand, when the firing temperature is at most 740° C., deformation of the glass plate can be avoided. In the present invention, as the glass plate, soda lime glass, alkali-free glass or quartz glass may, for example, be used.

The conductive printed wiring formed by the present invention, preferably has a resistivity of at most 20 μΩ·cm, whereby it can be used as a conductive printed wiring for various applications such as wirings. Further, the thickness of the conductive printed wiring is preferably from 5 to 30 μm. When the thickness is at least 5 μm, a constant resistivity can be readily obtained, and when the thickness is at most 30 μm, the desired thickness tends to be readily obtainable even by a single electro printing operation, and thus the handling efficiency will be excellent.

FIG. 2 is a schematic view illustrating a control process relating to a preferred embodiment of the present invention. On a glass plate pre-treated in ST1, a toner is printed in a predetermined pattern in the printing step ST2, and in the firing step ST3, the toner is fired by heating to obtain a glass plate with conductive printed wiring. In the inspection step ST4 after the firing step ST3, the resistance value of the conductive printed wiring is measured. The data of the measured resistance value are sent to a computer C for controlling the pattern of the toner in the printing step. If necessary, the temperature data in the firing step ST3 are also sent to the computer C. The data sent to the computer C are utilized as data to judge whether or not the desired electro heating performance or antenna performance is obtained. If it is judged that the desired performance is not obtained, by calculation by the computer C, the line width of the toner to be printed or the printing pattern itself is adjusted so as to obtain the desired performance. The adjusted line width of the toner or printing pattern is fed back to the printing step ST2 to form the next conductive printed wiring on the glass plate.

If a desired electro heating performance or antenna performance can be obtained by such feeding back, it is possible to produce glass plates with conductive printed wiring in a large quantity by fixing the control data.

Further, in a case where the glass plate G is used for a window of an automobile, the computer C may be used to store the data of the shapes of glass plates depending upon the types of automobiles and the data of the patterns for conductive printed wiring, so that in the production of a glass plate for a certain type, an order based on the data relating to the pattern for a conductive printed wiring corresponding to that type is transmitted to the electro printer, whereby a change from one type to another can easily be carried out, and printing depending on each type can be carried out. Further, an order based on the data of the shape of a glass plate among data relating to various types, is transmitted to the cutting and chamfering step (ST1) for a glass plate, whereby a change from one type to another can easily be carried out, and cutting and chamfering depending on each type can be carried out.

In the printing step ST2, not only a conductive toner but also a colored toner may be printed on the glass plate surface. For example, on a rear window of an automobile illustrated in FIG. 3, conductive printed wires (defoggers 1, antenna wires 2 and bus bars 3) are provided at the center region of the glass plate G, and a dark colored ceramic fired product 4 is provided at the peripheral region. On the photoconductor drum shown in FIG. 1, a colored toner having a pigment is further printed in a predetermined pattern, whereby the colored toner may be printed together with the conductive toner on the glass plate surface. Like the conductive toner, a colored toner used to be printed by screen printing. Accordingly, by electro printing a colored toner together with the conductive toner in such a manner, the production method can be made suitable for mass production.

### EXAMPLES

Now, Examples 1 to 6 (Examples of the present invention) and Examples 7 to 13 (Comparative Examples) will be presented. In these Examples, with respect to the decomposition temperature, using a thermogravimetric analyzer (model: DTG-50, manufactured by Shimadzu Corporation), the measurement was carried out from room temperature to 700° C. at a temperature raising rate of 10° C./min, whereby the temperature T₁₀₀ at which a weight change of the resin disappears and a temperature T₉₀ at the time when the weight reduction of the resin has become 90%, were obtained.

Further, the average molecular weights of the resins used in Examples 1 to 6, 8, 9 and 12 are weight average molecular weights, and the average molecular weights of the resins used in Examples 7, 10 and 11 are number average molecular weights.

### Example 1

In a container made of stainless steel (SUS304) and having a capacity of 200 mL, 20 parts by mass of maleic anhydride-modified polypropylene (manufactured by Sanyo Chemical, tradename: YUMEX 110TS, average molecular weight: 12,000, acid value: 7, T₁₀₀=450° C., T₉₀=435° C.), 79 parts by mass of silver powder (average particle size: 2 μm) and 1 part by mass of glass frit (bismuth-silica non-lead glass frit, melting temperature: 450° C., average particle size: 2 μm) were mixed, heated to 180° C., kneaded and then cooled to room temperature to obtain a solid product. This solid product was pulverized by a jet mill and classified to obtain a toner having an average particle size of 20 μm.

Using this toner, a thin line having a line width of 1 mm and a length of 80 mm was printed on a sheet glass having a size of 30 cm×30 cm by an electro printing machine and then fired at 700° C. for 4 minutes to form a conductive printed wiring. With respect to this conductive printed wiring, the following evaluations were carried out. The evaluation results are shown in Table 1. Also in the following Examples 2 to 13, evaluations were carried out in the same manner, and the results are shown in Table 1.

Evaluation of Adhesion

By an optical microscope, the adhesion portion with the conductive printed wiring was observed from the rear side of the glass plate to ascertain the presence or absence of peeling and adhesion defect of the conductive printed wiring. Here, the adhesion defect is meant for a case where the conductive printed wiring is not securely adhered to the glass plate surface and is in a suspended state. In the evaluation, a case where no peeling was observed, was rated as A; a case where not more than five adhesion defects with a diameter of not more than 0.5 mm were observed at the interface between the glass plate and the conducive printed wire, was rated as B; a case where from 6 to 10 adhesion defects with a diameter of not more than 0.5 mm were observed at the interface, was rated as C; and case where at least 11 adhesion defects with a diameter of not more than 0.5 mm or adhesion defects exceeding 0.5 mm were observed, and no peeling of the conductive printed wiring was observed, was rated as D; a case where only a part of the conductive printed wiring was completely peeled, was rated as E; and a case where the conductive printed wiring was peeled entirely, was rated as F. In the evaluation, cases judged to be A, B and C, are regarded as “pass”.

Evaluation of Resistivity

The resistance of the conductive printed wiring was measured by a resistance measuring device (manufactured by Agilent, tradename: Nano Volt/Micro Ohm Meter 34420A), and the film thickness was measured by a feeler profilometer (manufactured by ULVAC, tradename: Dektak8). From the values of the resistance and the film thickness, the resistivity was calculated. Here, a case where the resistivity was not more than 20 μΩ·cm, is regarded as “pass”.

### Example 2

A toner having an average particle size of 20 μm was obtained in the same manner as in Example 1 except that maleic anhydride-modified polypropylene (manufactured by Sanyo Chemical, tradename: YUMEX 1003, average molecular weight: 20,000, acid value: 21, T₁₀₀=440° C., T₉₀=430° C.) was used.

### Example 3

A toner having an average particle size of 20 μm was obtained in the same manner as in Example 1 except that maleic anhydride-modified polypropylene (manufactured by Sanyo Chemical, tradename: YUMEX 1001, average molecular weight: 40,000, acid value: 26, T₁₀₀=450° C., T₉₀=435° C.) was used.

### Example 4

A toner having an average particle size of 20 μm was obtained in the same manner as in Example 1 except that maleic anhydride-modified polypropylene (sample manufactured by Sanyo Chemical, average molecular weight: 43,000, acid value: 38, T₁₀₀=430° C., T₉₀=420° C.) was used.

### Example 5

A toner having an average particle size of 20 μm was obtained in the same manner as in Example 1 except that maleic anhydride-modified polypropylene (manufactured by Sanyo Chemical, tradename: YUMEX 1010, average molecular weight: 30,000, acid value: 52, T₁₀₀=430° C., T₉₀=420° C.) was used.

### Example 6

A toner having an average particle size of 20 μm was obtained in the same manner as in Example 1 except that maleic anhydride-modified polypropylene (manufactured by Sanyo Chemical, tradename: YUMEX 100TS, average molecular is weight: 10,000, acid value: 3.5, T₁₀₀=380° C., T₉₀=370° C.) was used.

### Example 7 (Comparative Example)

A toner having an average particle size of 20 μm was obtained in the same manner as in Example 1 except that instead of the maleic anhydride-modified polypropylene, polypropylene (manufactured by Sanyo Chemical, tradename: VISCOL 660P, average molecular weight: 7, 900, T₁₀₀=380° C., T₉₀=365° C.) was used.

### Example 8 (Comparative Example)

A toner having an average particle size of 20 μm was obtained in the same manner as in Example 1 except that instead of the maleic anhydride-modified polypropylene, polystyrene (manufactured by Sanyo Chemical, tradename: HYMER ST-95, average molecular weight: 4,000, T₁₀₀=530° C., T₉₀=435° C.) was used.

### Example 9 (Comparative Example)

A toner having an average particle size of 20 μm was obtained in the same manner as in Example 1 except that instead of the maleic anhydride-modified polypropylene, polystyrene (manufactured by Sanyo Chemical, tradename: HYMER ST-120, average molecular weight: 10,000, T₁₀₀=460° C., T₉₀=445° C.) was used.

### Example 10 (Comparative Example)

A toner having an average particle size of 20 μm was obtained in the same manner as in Example 1 except that instead of the maleic anhydride-modified polypropylene, a polypropylene resin (manufactured by Sanyo Chemical, tradename: HYMER 330P, average molecular weight: 15,000, T₁₀₀=560° C., T₉₀=445° C.) was used.

### Example 11 (Comparative Example)

A toner having an average particle size of 20 μm was obtained in the same manner as in Example 1 except that instead of the maleic anhydride-modified polypropylene, a polypropylene resin (manufactured by Sanyo Chemical, tradename: HYMER TP-32, average molecular weight: 9,000, T₁₀₀=565° C., T₉₀=420° C.) was used.

### Example 12 (Comparative Example)

A toner having an average particle size of 20 μm was obtained in the same manner as in Example 1 except that instead of the maleic anhydride-modified polypropylene, a styrene acryl resin (manufactured by Sekisui Chemical, tradename: SE-1010, average molecular weight: 229,000, acid value: 18, T₁₀₀=540° C., T₉₀=460° C.) was used.

### Example 13 (Comparative Example)

A toner having an average particle size of 20 μm was obtained in the same manner as in Example 1 except that instead of the maleic anhydride-modified polypropylene, polymethyl methacrylate (manufactured by Sekisui Chemical, tradename: P-10934, T₁₀₀=450° C., T₉₀=355° C.) was used, and the temperature was raised to 200° C. to carry out the kneading.

TABLE 1

| | | | Film | |
|---|---|---|---|---|
| | | | thickness | Resistivity |
| | Adhesion | Resistance (Ω) | (μm) | (μΩ · cm) |
| Ex. 1 | B | 0.243 | 10.2 | 3.1 |
| Ex. 2 | A | 0.253 | 11.4 | 3.6 |
| Ex. 3 | A | 0.237 | 10.8 | 3.2 |
| Ex. 4 | A | 0.226 | 10.6 | 3.0 |
| Ex. 5 | A | 0.261 | 9.8 | 3.2 |
| Ex. 6 | B | 0.282 | 11.1 | 3.9 |
| Ex. 7 | F | Not measurable | — | — |
| | | due to peeling | | |
| | | of the film | | |
| Ex. 8 | D | 28.87 | 10.6 | 382.5 |
| Ex. 9 | E | Not measurable | 11.2 | — |
| | | beyond the | | |
| | | measurable limit | | |
| Ex. 10 | E | 20.41 | 9.8 | 250.0 |
| Ex. 11 | D | 10.11 | 10.3 | 130.2 |
| Ex. 12 | F | Not measurable | — | — |
| | | due to peeling | | |
| | | of the film | | |
| Ex. 13 | F | Not measurable | — | — |
| | | due to peeling | | |
| | | of the film | | |

From the results in Table 1, it is evident that in Examples of the present invention (Examples 1 to 6) wherein resins (A) to (C) were employed, glass plates with conductive printed wiring excellent in adhesion were obtained. Especially in the Examples of the present invention (Examples 2 to 5) wherein resins (A) to (C) having an acid value of from 20 to 100 were employed, glass plates with conductive printed wiring excellent in adhesion to the glass plates, were obtained.

### INDUSTRIAL APPLICABILITY

The present invention relates to a method for forming a conductive printed wiring on a glass plate and a conductive toner useful for such a method, and it is particularly useful for a process for producing a glass plate with conductive printed wiring for windows of automobiles.

The entire disclosure of Japanese Patent Application No. 2004-203556 filed on Jul. 9, 2004 including specification, claims, drawings and summary is incorporated herein by reference in its entirety.

What is claimed is:

1. A conductive toner comprising a thermoplastic resin (A) having carboxyl groups introduced and having T₁₀₀ of from 300 to 450° C., conductive fine particles, and glass frit-containing particles, where T₁₀₀ is a temperature at the time when a weight change of the resin has become no longer observed during a temperature rise from room temperature at a rate of 10° C./min by means of a thermogravimetric analyzer (TG).

2. The conductive toner according to claim 1, wherein the thermoplastic resin (A) has an acid value of from 20 to 100.

3. The conductive toner according to claim 1, wherein (T₁₀₀−T₉₀) of the thermoplastic resin (A) is from 1 to 15° C., where T₉₀ is a temperature at the time when weight reduction of the resin has become 90 wt % during a temperature rise from room temperature at a rate of 10° C./min by means of a thermogravimetric analyzer (TG).

4. The conductive toner according to claim 1, wherein the absolute value of the difference between the melting temperature Ts of the glass frit and said T₁₀₀ is at most 20° C.

5. A conductive toner comprising a polypropylene (B) having carboxyl groups introduced, conductive fine particles, and glass frit-containing particles.

6. The conductive toner according to claim 5, wherein the polypropylene (B) has an acid value of from 20 to 100.

7. The conductive toner according to claim 5, wherein (T₁₀₀−T₉₀) of the polypropylene (B) is from 1 to 15° C., where T₁₀₀ and T₉₀ are a temperature at the time when a weight change of the resin has become no longer observed, and a temperature at the time when weight reduction of the resin has become 90 wt %, respectively, during a temperature rise from room temperature at a rate of 10° C./min by means of a thermogravimetric analyzer (TG).

8. The conductive toner according to claim 5, wherein the absolute value of the difference between the melting temperature Ts of the glass frit and said T₁₀₀ is at most 20° C.

9. A conductive toner comprising a thermoplastic resin (C) having T₁₀₀ of from 300 to 450° C., conductive fine particles, and glass frit-containing particles, wherein the difference (Ts−T₁₀₀) between the melting temperature Ts of the glass frit and T₁₀₀ of the thermoplastic resin (C) is at most 20° C., and the difference (Ts−T₉₀) between said Ts and T₉₀ of the thermoplastic resin (C) is from 0 to 80° C., where T₁₀₀ and T₉₀ are a temperature at the time when a weight change of the resin has become no longer observed, and a temperature at the time when weight reduction of the resin has become 90 wt %, respectively, during a temperature rise from room temperature at a rate of 10° C./min by means of a thermogravimetric analyzer (TG).

10. The conductive toner according to claim 1, wherein the glass frit has a melting temperature Ts of from 350 to 500° C.

11. The conductive toner according to claim 5, wherein the glass frit has a melting temperature of from 350 to 500° C.

12. The conductive toner according to claim 9, wherein the glass frit has a melting temperature of from 350 to 500° C.

13. A process for producing a glass plate with conductive printed wiring, which comprises a step of printing the conductive toner as defined in claim 1 on a glass plate and a step of heating the glass plate having the toner printed thereon at a predetermined temperature and firing the toner, thereby to form a conductive printed wiring having a predetermined pattern on the glass plate, wherein in the printing step, the toner is printed on the glass plate by electro printing.

14. The process for producing a glass plate with conductive printed wiring according to claim 13, wherein after the step of firing the toner, the resistance of the conductive printed wiring formed on the glass plate is measured and the measured result is fed back to the printing step to adjust the printing width of toner.

15. The process for producing a glass plate with conductive printed wiring according to claim 13, wherein after the step of firing the toner, the resistance of the conductive printed wiring formed on the glass plate is measured and the measured result is fed back to the printing step to adjust the printing pattern of toner.

16. The process for producing a glass plate with conductive printed wiring according to claim 13, wherein in the printing step, together with said toner, a colored toner is printed on the glass plate.

17. The process for producing a glass plate with conductive printed wiring according to claim 13, wherein the step of firing the toner is carried out at a temperature of from 600 to 740° C.
